(19) United States
(12) Patent Application Publication
(10) Pub. No.: US 2021/0347287 A1
(43) Pub. Date: Nov. 11, 2021

(54) VEHICLE-MOUNTED REFRIGERATOR WITH PULL ROD LIMITING STRUCTURE

(71) Applicant: Foshan Alpicool Electric Appliance Co., Ltd., Foshan (CN)

(72) Inventors: Gangqiang Fan, Jiujiang (CN); Shaohui Chen, Yichun (CN); Pizhi Zhao, Qingyuan (CN); Junjie Qin, Nanning (CN); Tao Zeng, Foshan (CN)

(21) Appl. No.: 16/987,353

(22) Filed: Aug. 6, 2020

(30) Foreign Application Priority Data
May 6, 2020 (CN) 202020720463.6

(51) Int. Cl. B60N 3/10; F25D 11/00

(52) U.S. Cl. CPC B60N 3/104; F25D 11/003

(57) ABSTRACT

A vehicle-mounted refrigerator with a pull rod limiting structure, comprising a refrigerator body and a pull rod, wherein a pull rod connecting base is centrally arranged on an end face of the refrigerator body, pull rod connecting grooves are arranged on the top of both sides of the pull rod connecting base, two support legs of the pull rod are rotationally connected with the two pull rod connecting grooves respectively, and two side walls of the pull rod connecting base are configured with limiting projections which abut against side walls of the support legs when the pull rod is retracted to prevent the support legs from shaking. The invention has the advantages of simple structure and convenient use. The pull rod used can be limited when retracted so as to prevent it from shaking and making noises.

### TECHNICAL FIELD

The invention relates to the field of vehicle-mounted refrigerators, in particular to a vehicle-mounted refrigerator with a pull rod limiting structure.

### BACKGROUND

Vehicle-mounted refrigerators are common auxiliary appliances in automobiles today. For the convenient movement of a vehicle-mounted refrigerator, one end thereof is generally provided with a pull rod or a handle. Most pull rods are telescopic pull rods, but the telescopic pull rods have higher cost and are easy to damage. However, if high quality long pull rods are used, the pull rods will sag freely when retracted, and shake and make noises with the running of cars, affecting the comfort of passengers in the cars.

### SUMMARY OF THE INVENTION

The invention provides a vehicle-mounted refrigerator with a pull rod limiting structure, which has the advantages of simple structure and convenient use. The pull rod used can be limited when retracted so as to prevent it from shaking and making noises.

In order to achieve the purpose, the invention provides the following technical solution: a vehicle-mounted refrigerator with a pull rod limiting structure, comprising a refrigerator body and a pull rod, wherein a pull rod connecting base is centrally arranged on an end face of the refrigerator body, pull rod connecting grooves are arranged on the top of both sides of the pull rod connecting base, two support legs of the pull rod are rotationally connected with the two pull rod connecting grooves respectively, and two side walls of the pull rod connecting base are configured with limiting projections which abut against side walls of the support legs when the pull rod is retracted to prevent the support legs from shaking.

Preferably, the support legs are tubular support legs, and cambered surfaces thereof easily get stuck with the limiting projections without blocking.

Preferably, the limiting projections are strip convex blocks intended to increase the contact area between the limiting projections and the support legs.

Compared with the prior art, the invention has the following beneficial effects:

The invention has the advantages of simple structure and convenient use. The pull rod used can be limited when retracted so as to prevent it from shaking and making noises.

### BRIEF DESCRIPTION OF THE DRAWINGS

FIG. 1 is a 3D installation diagram of the invention; and

FIG. 2 is a local installation profile of the invention.

### DETAILED DESCRIPTION OF THE PREFERRED EMBODIMENT

The technical solution in the examples of the invention will be described clearly and completely as follows in combination with drawings in the examples. Apparently, the examples described are only some examples of the invention, but not all examples. Based on the examples of the invention, all other examples obtained by those of ordinary skill in the art without creative work should fall within the protection scope of the invention.

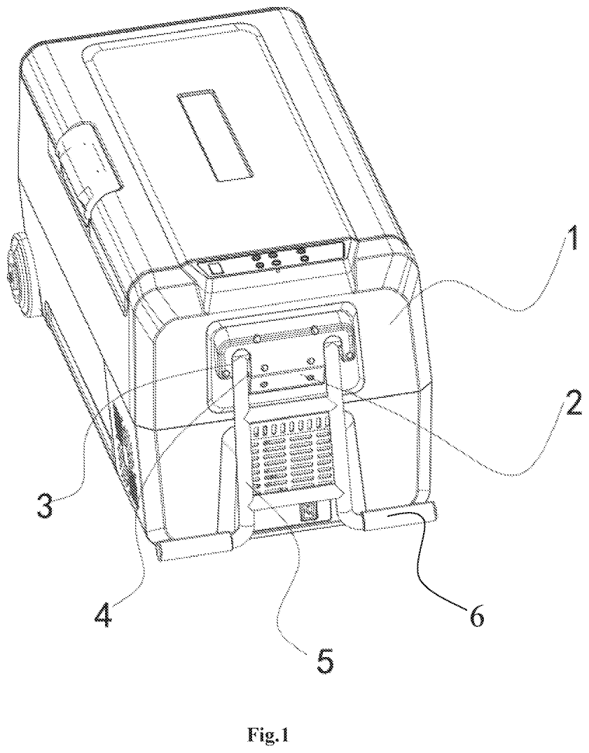

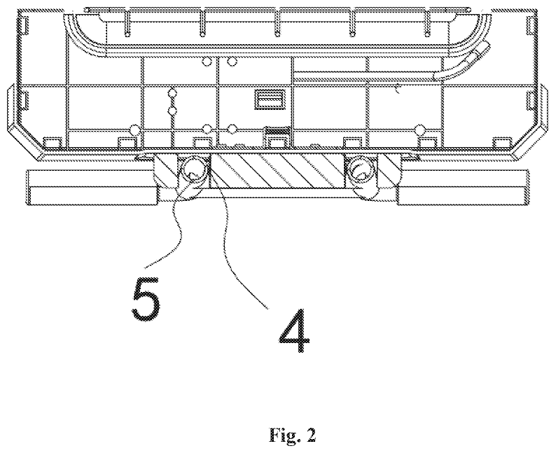

As shown in FIGS. 1-2, the invention provides a vehicle-mounted refrigerator with a pull rod limiting structure, comprising a refrigerator body (1) and a pull rod (6), a pull rod connecting base (2) is centrally arranged on an end face of the refrigerator body (1), pull rod connecting grooves (3) are arranged on the top of both sides of the pull rod connecting base (2), two support legs (5) of the pull rod (6) are rotationally connected with the two pull rod connecting grooves (3) respectively, and two side walls of the pull rod connecting base (2) are configured with limiting projections (4) which abut against side walls of the support legs (5) when the pull rod is retracted to prevent the support legs (5) from shaking.

The support legs (5) are tubular support legs, and cambered surfaces thereof easily get stuck with the limiting projections (4) without blocking.

The limiting projections (4) are strip convex blocks intended to increase the contact area between the limiting projections (4) and the support legs (5).

Although the invention has been described with reference to above examples, various improvements can be made thereto and components therein can be replaced with equivalents without departing from the scope of the invention. In particular, as long as there is no structural conflict, various features in the examples disclosed by the invention can be combined with each other in any way. The fact that these combinations are not exhaustively described in the specification is only for the sake of saving space and resources. Therefore, the invention is not limited to the specific examples disclosed herein, but includes all technical solutions falling within the scope of the claims.

1. A vehicle-mounted refrigerator with a pull rod limiting structure, comprising a refrigerator body (1) and a pull rod (6), and wherein a pull rod connecting base (2) is centrally arranged on an end face of the refrigerator body (1), pull rod connecting grooves (3) are arranged on the top of both sides of the pull rod connecting base (2), two support legs (5) of the pull rod (6) are rotationally connected with the two pull rod connecting grooves (3) respectively, and two side walls of the pull rod connecting base (2) are configured with limiting projections (4) which abut against side walls of the support legs (5) when the pull rod is retracted to prevent the support legs (5) from shaking.

2. The pull rod limiting structure of the vehicle-mounted refrigerator according to claim 1, wherein the support legs (5) are tubular support legs.

3. The pull rod limiting structure of the vehicle-mounted refrigerator according to claim 1, wherein the limiting projections (4) are strip convex blocks.
